(19) United States
(12) Patent Application Publication
(10) Pub. No.: US 2014/0042087 A1
(43) Pub. Date: Feb. 13, 2014

(54) BIOREMEDIATION OF PERSISTENT ORGANIC POLLUTANTS USING THERMOPHILIC BACTERIA

(71) Applicant: Thermocyclomics, LLC, (US)

(72) Inventors: Kevin O'Driscoll, Princeton, NJ (US); Raymond Sambrotto, Blauvelt, NY (US); Robert DiFilippo, West Chester, PA (US); Paul Piccillo, Chapel Hill, NC (US)

(73) Assignee: THERMOCYCLOMICS, LLC, New York, NY (US)

(21) Appl. No.: 13/758,490

(22) Filed: Feb. 4, 2013

Related U.S. Application Data
(60) Provisional application No. 61/594,530, filed on Feb. 3, 2012.

(51) Int. Cl. B09C 1/06; B09C 1/10; C02F 3/34

(52) U.S. Cl. CPC B09C 1/06; C02F 3/342; B09C 1/10
USPC 210/606; 210/612; 405/258.1

(57) ABSTRACT

The present application relates to a method of degrading organic contaminants in contaminated soil, sediment or wastewater, the method being carried out by treating the contaminated soil, sediment or wastewater with thermophilic bacterium capable of degrading the organic contaminants.

### FIELD

The present invention relates to bioremediation of contaminated substances, wastewater, soils, and sediments.

### BACKGROUND

Persistent organic pollutants (POPs) include the residual wastes of industry, such as polychlorinated biphenyls (PCBs), polyaromatic hydrocarbons (PAH), pesticide residues, polychlorinated dibenzo-p-dioxins and polychlorinated dibenzo-furans (PCDD/Fs).

The longevity of persistent organic pollutants in the environment is a risk to human health and the environment, and presents an economic barrier to sustainable use of natural resources, including land and waterways. An abundance of evidence suggests that such pollutants are a detriment to public health For example, among these organic compounds there are suspected human carcinogens, as well as causative factors in asthma, developmental and genetic disorders. The primary mechanism of human exposure is often through the food chain, but can also be by direct environmental exposures. Persistent organic pollutants are also a threat to the health of wild life and are generally considered a toxic stain of industry that is a detriment to both the natural environment, as well as to sustainable development in the future.

The scope of the problem of environmental contamination by persistent organic pollutants is worldwide. In the U.S., sites with acute and significant risks to human health are administered through the EPA's Superfund program, routinely under the direct management of the United States Army Corps of Engineers. As of January 2013, there were 1,312 sites on the National Priorities List (NPL). Although organic contaminants are not the only pollutant at many of these sites, they contribute significantly to the toxin exposure of approximately 11 million people in the U.S., including 3-4 million children, who live within 1 mile of a federal Superfund site. In addition to these acutely dangerous sites, urban revitalization often is limited by the environmental hazards posed by brown field sites containing organic pollutants. Such brown field sites remain out of useful service for decades due to the costs of remediation and the restrictions on development caused by potential pollutant exposure. This exclusion of land from commercial use can inflict significant economic harm to the local economies. A parallel problem exists on military properties.

Current methods for remediation of sites contaminated with persistent organic pollutants include both in-situ and ex-situ technologies. During ex-situ remediation, the contaminated soil is excavated and then subsequently remediated or disposed of elsewhere.

For ex-situ remediation a number of technologies are currently used, including high temperature thermal degradation, soil washing, and bioremediation. During thermal decontamination, soil is heated to temperatures between 400 and 800 degrees C., depending on the type of contaminant. At these temperatures, organic contaminants evaporate from the soil or decompose; the volatile contaminants are incinerated in a subsequent step. With soil washing, contaminated soil is separated into generally two fractions, a sand fraction and a residual fine fraction. The residual fine fraction contains most of the contaminants and therefore has to be disposed of, or remediated.

With in-situ remediation, the contaminated soil or sediment is kept in place and is treated by injecting different compounds or by withdrawing water or air from the soil to remove contaminants. In-situ remediation can also be applied to contaminated soils and sediments which have been previously removed from a contaminated area, processed in such a fashion that persistent organic pollutants are not reduced or eliminated, and which are then deposited in a landfill or other designated disposal site. For most of the persistent organic pollutants contaminants, listed above, no in-situ remediation method is currently available. U.S. Pat. No. 4,832,122 provides an example of methods for in-situ remediation of volatile contaminants from contaminated ground water with microorganisms which methods consists of using of two well systems, one for injecting a fluid and the other for extracting the fluid. See also, Perelo, L. W., Review: In Situ And Bioremediation Of Organic Pollutants In Aquatic Sediments, J. Hazard. Mat. 2010; 177:81-89, which differentiates traditional sediment remediation techniques in use, such as dredging, capping and monitored natural attenuation, from more recent approaches with emphasis on bioremediation.

Bioremediation is a broad term, which makes reference to the activity of microorganisms in degradation of contaminants in the environment by biological methods inherent to the metabolic potential of the microorganisms. Bioremediation usually makes use of those microorganisms naturally occurring in a given microfauna at a given site, but can be used more broadly to make reference to the addition of exogenous microbes. The term biostimulation makes reference to the need to provide microorganisms with nutrients such as nitrogen and phosphorus, cofactors such as electron acceptors in anaerobic environment, or oxygen, these additives serving to stimulate the rate of bioremediation (see for instance Richardson, et al., Desorption And Bioavailability Of PAHs In Contaminated Soil Subjected To Long-Term In-Situ Biostimulation, Environ. Toxicol. Chem. 2011; 30:2674-2681. Bioaugmentation, is a form of bioremediation, where there is the introduction of microorganisms with specific catabolic abilities into the contaminated environment in order to supplement the indigenous population and to speed up or enable the degradation of pollutants. See for example, Payne, et al., Enhanced Reductive Deschlorination Of Polychlorinated Biphenyl Impacted Sediment By Bioaugmentation With A Dehalorespiring Bacterium, Environ. Sci. Technol. 2011; 45:8772-8779.

The use of bioremediationto break down and metabolize organic pollutants is known, particularly for treating industrial wastewater and domestic sewage. Several organisms have been identified as having the ability to break down chlorinated substances in soil and in water. Examples of methods for decomposition of dioxins using microorganisms include a method for treating a liquid containing dioxins, and are disclosed in JP 2002-028695 A. See also JP 2001-090353 A, wherein methods of extraction of dioxins include trapping of dioxins in aqueous solution, or sorption of dioxins to a solid, where they can be degraded by fungi.

Geobacillus sp., athermophile and gram positive bacillus, provisionally designated the species midousuji, is known as a microorganism for decomposing dioxins. See for example, Sadayori Hoshinaetet et al., “Decomposition Experiment Of Dioxins By Thermophile And Gene Analysis”, Collected Papers II From 10th Annual Conference Of The Japan Society Of Waste Management Experts, The Japan Society of Waste Management Experts, p. 883-885, Oct. 10, 1999. JP 2002-301466 A and U.S. Pat. No. 7,598,074 disclose methods for cleaning a contaminated matter using Geobacillus sp. (midousuji) both of which are herewith incorporated by reference.

Persistent organic pollutants, and particularly the xenobiotic chlorinated polyaromatics, such as polychlorinated biphenyls, and polychlorinated dibenzo-p-dioxins and polychlorinated dibenzo-furans, are known to be degraded by several types of bacteria. For example, several pure strains of bacteria that grew at elevated temperatures were isolated from a community composting facility located in urban Osaka, Japan, and were designated strains SH2A-J1, SH2B-J2 and SH2B-J3, respectively. The SH2B-J2 strain related to Geobacillus sp. (midousuji) demonstrated in bench-scale experiments to possess aerobic, enzymatic activity capable of degrading polychlorinated biphenyls, polyaromatic hydrocarbons and polychlorinated dibenzo-p-dioxins and polychlorinated dibenzo-furans. U.S. Pat. Nos. 6,190,903 and 6,420,165, disclose methods for the isolation of Geobacillus sp. (midousuji), both of which are herewith incorporated by reference in their entirety.

Despite these advances in basic research, however, there remains an unmet need in the environmental remediation industry for effective and permanent methods to eliminate persistent organic pollutants from contaminated sites and a need for better and less expensive methods for disposing of toxic substances.

### SUMMARY

Applicants have found that levels of several of the most prominent of these persistent organic pollutants can be reduced in the presence of a thermophilic microorganism acting as a bioremediation agent. Applicants have found that the thermophilic bioremediation process is capable of degradation of aromatics that include some of the most toxic and environmentally persistent compounds, such as polychlorinated bi-phenyls (PCBs), polyaromatic hydrocarbons (PAHs; including benzo[a]pyrene) and dibenzyl dioxins and dibenzyl furans (PCDD/Fs). The bioremediation process of the present invention may be performed in-situ to remove such contaminants from various environments including soils or sediments or groundwater or wastewater, that are present at industrially impacted sites without major excavation or following excavation and removal to a landfill or land-farm facility. The bioremediation process of the present invention may also be performed ex-situ making use of a bioreactor utilizing enzymatic catalysis to remove such contaminants from various environments including soils or sediments or groundwater or wastewater, that are present at industrially impacted sites following excavation and removal to a processing facility. These sites can include waste disposal sites landfills, dumps, military installations, railroad yards, incinerator stations, chemical and dye factories, tannery or mill yards, airfields, racetracks, manufacturing sites, electrical generating stations, oil refineries, petroleum storage, transfer or filling stations, petrochemical facilities, manufactured gas sites, and other brown fields where residual persistent organic pollutants contamination exists.

There are two general methods in which bioremediation using a thermophilic bacteria such as the Geobacilli may be implemented. In the first method, the live bacterium can be dispersed in the environment under conditions supportive of its inherent bioremediation activity. In the second method a cell-free methodology can be developed in which environmental conditions are optimized for enzymatic catalysis of specific target contaminants by Geobacillus-encoded enzymes. The cell-free methodology can utilize enzyme preparations, either by crude extractions, or by more refined enzyme systems with differing degrees of purity and consisting of different mixtures of enzymes encoded by distinct genes. Thus, either the live cell approach, or alternatively, the cell-free approach utilizing an enzyme preparation, these systems can be implemented as a bioremediation method for permanent removal of persistent organic pollutants from the environment.

The present invention provides a methods for removal by enzymatic catalysis of contaminated matter comprising persistent organic pollutants by decomposing the pollutants in the contaminated matter, wherein the method comprises a reaction which brings into contact either whole cells from thermophilic bacteria, or mutants thereof, or enzymes extracted and purified from thermophilic bacteria into a field of influence of the reactions, or bioreactor, or reaction vessel, holding at least contaminated soils or sediments or groundwater or wastewater or some combination of these, under conditions which permit the enzymatic catalysis of the pollutants. Therefore, the methods of the present invention allows for control of cleaning the contaminated matter.

In one variant, the present invention provides a method for in-situ removal of persistent organic pollutants from industrially impacted sites, which method comprises pretreating the site and then subjecting the site to heat in the presence of a thermophilic bacillus or enzymes present in a cell extract of a thermophilic bacillus.

In one variant, the present invention provides a method for in-situ removal of persistent organic pollutants from industrially impacted sites, wherein the thermophilic bacilli is Geobacillus midousuji.

In one variant, the present invention provides a method for in-situ removal of persistent organic pollutants from industrially impacted sites, wherein the Geobacillus midousuji is the strain SH2B-J2.

In one variant, the present invention provides a method for in-situ removal of persistent organic pollutants from industrially impacted sites, wherein the thermophilic bacilli is an endemic strain of thermophilic bacteria present at the impacted site, such as, for example Geobacillus thermodinitrificans.

In one variant, the present invention provides a method for in-situ removal of persistent organic pollutants from industrially impacted sites, wherein the heating required for the thermophilic bacilli activity is much lower than established thermal degradation methods that are presently used in the industry.

In one variant, the present invention provides a method for in-situ removal of persistent organic pollutants from industrially impacted sites, wherein the heating required for the thermophilic bacilli activity is approximately in the range of from about 50° C. to about 100° C.

In one variant, the present invention provides a method for in-situ removal of persistent organic pollutants from industrially impacted sites, wherein the heating required for the thermophilic bacilli activity is approximately 70° C.

In one variant, the present invention provides a method for in-situ removal of persistent organic pollutants from industrially impacted sites, wherein the heating required for the thermophilic bacilli activity is achieved by introduction of energy in the form of electrical current, steam, heated gas, or geothermal energy, each separately contemplated.

In one variant, the present invention provides a method for in-situ removal of persistent organic pollutants from industrially impacted sites, wherein pretreatment include bioventing, air sparging, redox sparging, soil-venting or hydraulic fracturing each separately contemplated.

In one variant, the present invention provides a method for in-situ removal of persistent organic pollutants from industrially impacted sites, wherein pretreatment includes in-situ extraction of persistent organic pollutants bound to native soil and sediment residues such as humic acids.

In one variant, the present invention provides a method for in-situ removal of persistent organic pollutants from industrially impacted sites, wherein the impacted site includes contaminated soils, sediments, water and industrial wastes.

In one aspect, the present invention provides a method for in-situ removal of persistent organic pollutants from industrially impacted sites resulting in lower energy costs compared to standard disposal methods, such as high temperature thermal degradation or total incineration of persistent organic pollutants.

In one variant, the present invention provides a method for ex-situ removal of persistent organic pollutants from industrially impacted sites, which method comprises the use of enzymatic catalysis to remove such contaminants from various environments, including soils or sediments or groundwater or wastewater, that are present at industrially impacted sites following excavation and removal to a processing facility.

In one variant, the present invention provides a method, which method comprises the use of enzymes and catalytic cofactors isolated from thermophilic bacteria such as Geobacillus sp., as well as additional catalytic cofactors such as electron donors, electron acceptors, prosthetic groups, metal ions, energy-containing molecules, biostimulants, etc. in a cell-free system in association with a silica-based media which has the effect of greatly enhancing the rate of catalysis of persistent organic pollutants.

### BRIEF DESCRIPTION OF THE FIGURES

FIG. 1 shows morphological and genetic properties of G. midousuji strain SH2B-J2.

A. Left) panel represents scanning electron microscopy

A. Right) panel represents Gram-stain, phase-contrast microscopy

B. 16s Ribosomal DNA sequence phylogenetic tree

FIG. 2 shows the thermophilic biodegradation of dioxin and PCBs in contaminated soil and sediment

A. Left) Dioxin concentrations (2,3,7,8 TCDD pg-TEQ/g) in contaminated soil before and after incubation with G. midousuji strain SH2B-J2.

A. Right) Total Aroclor (PCB) concentrations (ppm) in contaminated river sediments before and after incubation with G. midousuji strain SH2B-J2.

B. Shows the rate of degradation of total Arochlor (PCBs) by an enzyme preparation of strain SH2B-J2.

FIG. 3 shows a schematic illustration of methods of soil pretreatment and washing.

FIG. 4 shows a schematic illustration of a micro/nano scale fluidized bed reactor.

FIG. 5A shows schematic illustration of a micro/nano scale thermostable enzyme bioreactor.

FIG. 5B shows schematic illustration of a sequential micro/nano scale thermostable enzyme bioreactor.

FIG. 6 shows a schematic illustration of a solid-state degradation bioreactor.

FIG. 7A illustrates an example of a conventional in-situ injection methodology applicable to bioremediation with thermophilic bacteria using vertical well borings.

FIG. 7B illustrates an example of a conventional in-situ injection methodology applicable to bioremediation with thermophilic bacteria using horizontal well boring.

FIG. 7C illustrates an example of a conventional in-situ injection methodology applicable to bioremediation with thermophilic bacteria using infiltration gallery.

FIGS. 8A-8B shows schematic illustrations of land farming approaches to applicable to bioremediation with thermophilic bacteria. FIG. 8A shows Quonset huts and FIG. 8B shows an aerial view of earth tillers.

### DETAILED DESCRIPTION

To date, there has been little progress in the practical applications concerning the breakdown of recalcitrant organics such as PCBs, PAHs, PCDD/Fs, particularly in the highly weathered and adsorbed states in which they typically are found as residual and persistent environmental contaminants.

In general, bioremediation refers to the transformation of contaminants into simple and less toxic molecules by naturally occurring microbes, by enzyme systems, or by genetically engineered microorganisms. This process can be carried out in-situ or ex-situ in a reaction vessel, under anaerobic or aerobic conditions and alone or in combination with other treatment methods.

Applicants have found that isolates of thermophilic bacteria of the genus Geobacillus, which grows only above the approximate temperature of 60°, can carry out the breakdown of aromatic ring compounds at lower temperatures at proportionally lower rates, or at temperatures as high as 100° C. under aerobic conditions.

Wastewater or “related wastewater” or “derivative wastewater” as used herein, unless otherwise indicated, shall mean supernatants derived by solid-liquid phase extraction methods and differs from sludge which is defined as sewage produced by the wastewater treatment process.

As used herein, unless otherwise indicated, the “delivery system” for pretreatment of the soil can take the form of (a) borings either vertical or horizontal, or galleries installed at a site to be remediated into which are inserted hollow pipes or geoprobes or properly designed well screens capable of transmission of fluids, gases and suspensions therein; or (b) equipment designed and manufactured specifically to manage waste flows in the form of batch or continuous extractions, centrifugation, sonic disruption, hydraulic fracturing, or similar methods of infusion of fluids and suspensions.

As used herein, unless otherwise indicated, the “delivery system” for bringing the bacteria or enzymes derived from the related bacteria can take the form of (a) borings either vertical or horizontal, or galleries installed at a site to be remediated into which are inserted hollow pipes or geoprobes or properly designed well screens capable of transmission of fluids, gases and suspensions therein; or (b) equipment designed and manufactured as a reaction vessel for solid phase, fluidized bed, slurry or immobilized bed reactor or similar incubation device capable of holding at a given temperature a volume of reactant.

Thermophilic bacterium as used herein, unless otherwise indicated, includes bacteria that are capable of degrading aromatic hydrocarbons.

Persistent organic pollutants (POPs) as used herein include, but are not limited to, polychlorinated biphenyls (PCBs) and polyaromatic hydrocarbons (PAH), or polychlorinated dibenzo-p-dioxins and polychlorinated dibenzo-furans (PCDD/Fs) and pesticide residues and other POPs that are recognized by regulatory bodies to be problematic and limiting to redevelopment due to risk-based assessments, or other mandates, as described by local, state and federal legislation and or other civil authorities.

Two major aspects of the Geobacillus thermophilic degradation biotechnology differentiate it in terms of applications in the bioremediation industry. Firstly the thermophilic nature of this microorganism differentiates it from other commercial products and processes. Yet the level of heating required for Geobacillus activity (70° C.) is much lower than established thermal methods in the industry, and requires lower energy costs compared to standard disposal methods such as high temperature thermal degradation or total incineration of Persistent organic pollutants. Secondly, in comparison to other microbes used in commercial applications, the thermophilic bioremediation agent has proven to be relatively nonselective in terms of substrate specificity. One strain contemplated herein is provisionally designated Geobacillus midousuji SH2B-J2, which has shown potent catalytic activity against PCBs, PAHs and dibenzyl dioxins and dibenzyl furans, each separately contemplated. The catabolic activity of the thermophilic bioremediation agent may thus provide a cost-effective method for permanent removal of several structurally disparate organic toxins from contaminated soils, sediments, water and industrial wastes, each separately contemplated.

In one aspect, the present invention provides a method of degrading POPs present in soils and sediments and wastewater; said method comprising exposing contaminated soil or sediment or wastewater to a thermophilic bacterium strain, wherein the soil or sediment or wastewater is pretreated with chemical extraction agents to enhance the access of the thermophilic bacteria and its enzymes to POPs that are bound tightly to organic matter. This extraction also can be extended using methods such as solid liquid phase extraction and/or washing under acidic condition.

In an embodiment, the present invention provides an in-situ method of degrading POPs present in soils or sediments or wastewater, said method comprising

(a) pretreating the soil or sediment or wastewater with acidic or base extraction method by means of a delivery system (i.e., vertical well field, horizontal well field or injection gallery;

(b) exposing the soil or sediment or wastewater to a thermophilic bacterium capable of degrading aromatic hydrocarbons by means of a delivery system, together with a growth substrate and/or oxygen, for supplementing the growth of the microbes;

(c) subjecting soil to an energy source to heat the soil for a period of time sufficient to result in marked reductions in the levels of POPs;

(d) aerating the soil at the same time or before the introduction of the energy source;

(e) monitoring the degradation of the POPs and off-gases emitted from sediments and such off-gasses will be managed through conventional air treatment technologies (i.e., granular activated carbon or an equivalent technology).

In another embodiment, the thermophilic bacterium strain is Geobacillus midousuji strain J2 (SHB2-J2), or related thermophilic bacterium strain, such as for example Geobacillus thermodinitrificans.

In another embodiment, the first delivery system in step (a) and the second delivery system in step (b) are identical.

In another embodiment, the present invention provides remediation of the POPs such as polychlorinated biphenyls and polyaromatic hydrocarbons, or polychlorinated dibenzyl dioxins and dibenzyl furans.

In another embodiment, the present invention aromatic hydrocarbons include, but are not limited to, PCBs and PAHs.

In one embodiment the method defined above is carried out in a pH range of 5 to 9.

Acidic or base extraction method includes manipulation of the reductive and oxidative environments in soils local to the presence of POPs such that organic compounds such as those bound to native components of soils such as humic acids are made more accessible to biodegradation.

Pretreatment of the contaminated soil may be done by means of vertical or horizontal drilled wells, or by an excavated gallery. Pretreatment of the contaminated soil may also be done by creating fractures and fissures using fluid pressure introduced through spaced apart soil borings drilled to selected depths;

Examples of pretreatment include drilling and injecting air, oxygen, or peroxide to create an oxidative environment (bioventing, sparging), spraying or soil-venting or hydraulic fracturing aka fracking (injecting liquid into soil at high pressure).

Subjecting soil to an energy source to heat the soil for a period of time sufficient to result in marked reductions in the levels of POPs, may be done by subjecting the soil to an electrical current, heat from flame, natural gas, steam or geothermal energy. Preferably the soil is heated to a temperature of 60 to 100 degrees C.

In another embodiment, biodegradation of the present application can be enhanced by subjecting the bacterium to a heating, such as electrical current, steam and geothermal energy and a growth substrate.

To increase the bioavailability of the substrate the soil may be aerated by oxygen generator or injection.

Monitoring the degradation of the POPs in step (e) may be done by vertical monitoring wells which intercept the media and can be tested using chemical analysis.

In another aspect, the present invention provides a method for ex-situ removal of persistent organic pollutants from industrially impacted sites, which method comprises the use of enzymatic catalysis to remove such contaminants from various environments, including soils or sediments or groundwater or wastewater, that are present at industrially impacted sites following excavation and removal to a processing facility.

In yet another aspect, the present invention provides a method for removal of persistent organic pollutants, which method comprises the use of enzymes and catalytic cofactors isolated from thermophilic bacteria such as Geobacillus sp., as well as additional catalytic cofactors such as electron donors, electron acceptors, prosthetic groups, metal ions, energy-containing molecules, biostimulants, etc. in a cell-free system in association with a silica-based media which has the effect of greatly enhancing the rate of catalysis of persistent organic pollutants.

### Origin of the Isolates, Culture Methods and Media, Morphological and Growth Characteristics.

Thermophilic Geobacilli were isolated from a sample of compost collected in Osaka, Japan. The strain was provisionally named Geobacillus midousuji after the location Midousuji in Osaka, Japan, and its metabolic and catalytic capacities were investigated. Regular aerobic and aseptic techniques were used in all experiments. Strains SH2A and SH2B were cultured on trypticase soy medium (BBL) at 64° C., and strains SH2A-J1, SH2B-J2 and SH2B-J3 were isolated as single colony clones. Aerobic growth of this bacterial strain occurs at temperatures between 57° C. to about 100° C., and at a pH ranging from about 5.0 to about 8.0. Strain SH2B forms sticky colonies on trypticase soy agar and shows filamentous growth in trypticase soy broth. Both SH2A and SH2B strains can be considered to be extreme thermophiles since they require at least 57° C. to undergo cellular replication. The strains SH2A-J1, SH2B-J2 and SH2B-J3, were demonstrated to be dependent on temperatures greater than 57° C. for growth in pure culture, and had an optimal growth curve at 65° C.

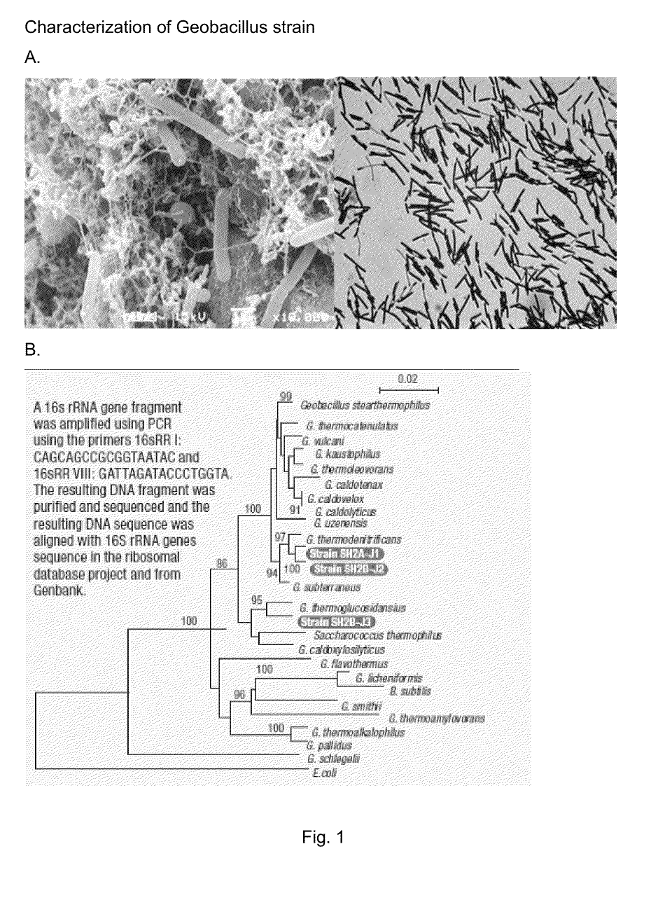

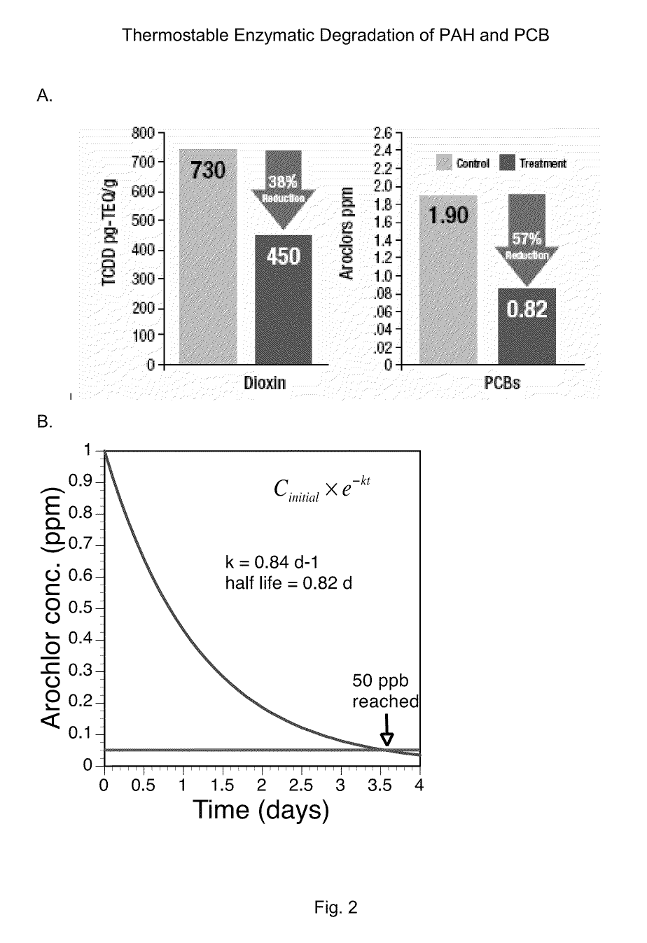

Additional evidence was obtained for spontaneous sporulation by G. midousuji strain SH2B when Nutrient agar was inoculated and then incubated at 64° C. for 5 days which demonstrated the presence of spores. The bacterial strain herein designated G. midousuji strain SH2B-J2 was cultured as single colonies and then subjected to microscopy. Rod-shaped bacteria in pure cultures of G. midousuji strain SH2B were observed by electron microscopy and these also stained strongly positive with Gram's stain (See FIG. 1A).

Isolation of genomic DNA from G. midousuji strains SH2B-J1, J2, and J3, polymerase chain reaction (PCR) amplification, and purification of the 16S rRNA gene fragment were performed using commercially available kits (Qiagen). The purified PCR products corresponding to 16s Ribosomal DNA nucleotides 8-806 was directly sequenced by dideoxy terminating cycle (Applied Biosystems). The resulting DNA sequence for the 16S rRNA gene was aligned with 16S rRNA sequences obtained by query of the nucleotide blast search engine from the NCBI Genbank. DNA homology of 16S ribosomal gene sequences demonstrated close phylogenetic relationships between strains SH2A-J1, SH2B-J2 and Geobacillus thermodinitrificans, and between strain SH2B-J3 and Geobacillus thermoglucosidansius (See FIG. 1B).

Further evidence was obtained that pure cultures of G. midousuji strain SH2B-J2 grown in a minimal medium were capable of growth using several organic compounds as their sole carbon source to replicate cellular growth and synthesize protein (Table 1). Minimal media supplemented with sole carbon source chemicals (Sigma) were inoculated with a loopful of bacteria and incubated at 64° C. for 1 day, subsequently then the presence of protein in the culture was determined by the method of Lowry. The sole carbon sources which were metabolized to form protein by G. midousuji strain SH2B-J2 included dibenzofuran, dibenzodioxin, anthracenes, organic acids, and several alkanes.

TABLE 1
Growth of G. midousuji Strain SH2B-J2on
Various Sole Carbon Sources

| | | Protein concentration |
|---|---|---|
| Chemical Class | Carbon Source | (micrograms/milliliter) |
| PAH | Napthalene | 0 |
| | Biphenyl | 0.2 |
| | Diphenyl ether | 1.0 |
| | Dibenzofuran | 2.4 |
| | Dibenzo-p-dioxin | 2.4 |
| | Fluorene | 0 |
| | Dibenzo-thiophene | 1.8 |
| | Phenanthrene | 3.2 |
| | Carbazole | 0 |
| | Anthrone | 4.2 |
| | Fluoranthene | 1.2 |
| | 2,4,8-Trichlorodibenzofuran | 6.0 |
| | Pyrene | 3.0 |
| | Perylene | 1.0 |
| | Xylene | 0.4 |
| Organic Acid | Sodium pyruvic acid | 20.0 |
| | Sodium maleic acid | 25.0 |
| | Sodium lactic acid | 22.0 |
| n-alkane | Hexadecane | 10.0 |
| | Heptadecane | 4.2 |
| | Heptane | 3.0 |
| | Tetradecane | 8.5 |

### Biodegradation of PCBs, PAH and PCDD/Fs by Strain SH2B

G. midousuji strains SH2A and SH2B have been shown to degrade household wastes including polyethylene, fish heads and other organic matter such as wastewater sludge (See U.S. Pat. Nos. 6,190,903 and 6,420,165). Strain SH2B-J2 was demonstrated in bench-scale experiments to possess aerobic, enzymatic activity capable of degrading PCBs, PAHs and PCDD/Fs. When various isomers of PCDDs and PCDFs were analyzed greater than 99% of total PCDDs and PCDFs were eliminated during the incubation with strain SH2B-J2. When various isomers of PCBs were analyzed it was found that 89% of non-ortho PCBs, and 73% of mono-ortho PCBs were eliminated during the incubation with strain SH2B-J2. Trypticase soy broth containing each isomeric PCB was inoculated with strain SH2B-J2 and was incubated at 64° C. for up to 5 days. The results obtained with GC-MS-metabolite analysis revealed breakdown products including products characteristic of catabolic activities as shown by Hoshina, et al., (2011) Degradation of persistent organic pollutants using a thermophilic bacterium. Abstract C-18, in: E. A. Foote and A. K. Bullard (Conference Chairs), Remediation of Contaminated Sediments—2011, Sixth International Conference on Remediation of Contaminated Sediments (New Orleans, La.; Feb. 7-10, 2011), ISBN 978-0-9819730-3-6, Battelle Memorial Institute, Columbus, Ohio. Taken together, these findings suggested that Geobacillus midousuji strain SH2B encodes a pathway of catalytic activities, which may be of utility in bioremediation of soils and sediments contaminated with these POPs.

### Thermophilic Degradation of POPs by a Live Cells and an Enzyme Preparation of Strain SH2B-J2

Thermophilic Degradation of Dioxins and PCBs in Contaminated Soil and Sediment.

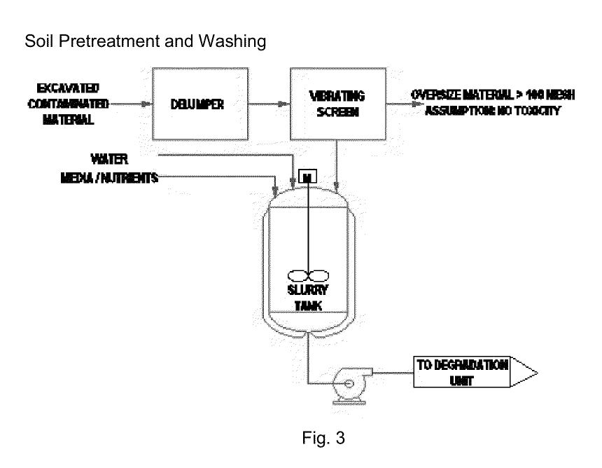

In order to determine if the G. midousuji SH2B-J2 strain exhibited the biodegradative action on persistent organic pollutants found in natural soils and sediments, bench scale incubations were used to assess the reduction in levels of dioxin and PCBs in real world contaminated samples. The dioxin (total TCDDs) contaminated soil was obtained from an industrial site in Tokyo Japan, and the PCB contaminated river sediment was obtained from the Hudson River in Yonkers, N.Y. Samples containing 100 g of contaminated soil or sediment were homogenized and mixed with and equal volume of two-fold concentrated trypticase soy broth. These were then inoculated with live strain SH2B-J2, and were incubated with rotation or shaking at 70° C. for 24-72 hours. Samples were extracted with methylene chloride by an accelerated solvent extractor and analyzed by a GC-MS. When dioxin contaminated soil was incubated with strain SH2B-J2 at 70° C. for 72 hours 38% of TCDD was eliminated (See FIG. 3A left). Similarly, when PCB contaminated Hudson River sediment was incubated with strain SH2B-J2 at 70° C. for 24 hours 57% of total Aroclors (a mixture of PCB conjeners) were eliminated as determined by GC-MS analysis. (See FIG. 3A right). The rate constant for degradation of total Arochlors was determined to be 0.84 per day (See FIG. 3 B).

Based on these experiments the testing of live SH2B-J2 cells in pilot scale fermentations containing contaminated soils and sediments suggested that G. midousuji strain SH2B-J2 produced marked reductions in the levels of PCBs and dioxin in real world samples (See FIG. 3 and Table 2). In order to further assess the biodegradative catalysis of strain SH2B-J2 additional experiments were carried out to replicate potential bioremediation systems using either whole cells or a cell-free method base on an enzyme preparation obtained by sonication of the cells and subcellular fractionation methods. (Table 2).

In experiment 1, the matrix of a PCB contaminated upland soil was treated with a cell extract. No prior treatment of the soil was done. The soil was incubated in moist conditions while mixing. The pollutant tested for was an Aroclor mixture as detected by EPA method 8082. The reaction rate for this experiment ranged from 15-36% per day.

In experiment 2, the matrix of a contaminated river mud from the Hudson River was exposed to live cells. No prior treatment of the sediment was done except for the addition of media to support cell growth. Two pollutants were tested: an Aroclor mixture as defined by EPA 8082 and Dioxin mixture expressed as tetrachlorinated dibenzo-dioxin equivalents. The Aroclor mixture showed a decrease of 84% per day and the Dioxin showed a decrease of 48% per day.

### Thermophilic Degradation of Toxic Organic Compounds by an Enzyme Preparation of Strain SH2B-J2 in Silica-Based Media

In experiment 3, the matrix of a pre-cleaned sand was treated with cell extract. The pollutants tested were benzo[a]pyrene (BaP), the most toxic PAH compound, and 2,3′,4′,5-tetrachlorobiphenyl (TCB) which are present in Hudson River sediments. The pollutants in methanol solution were added to 7 g of sand, dried under a flow of N₂ and then incubated with 100 mg of strain SH2B-J2 crude enzyme extract in 10 ml of milli-Q water at 70° C. with mixing for 96 hours. Changes in pollutant levels were estimated by gas chromatography-mass spectrometry. Although calibrated concentrations for this experiment are not available, the relative decrease in the size of the peak between the control and the experimental incubation was approximately 95% for both the BaP and TCB. This decrease was used as the basis for the reaction rate (K) in the Table 2 below.

TABLE 2
Thermophilic Degradation of POPs by a Live Cells
and an Enzyme Preparation of Strain SH2B-J2
Experiment 1 - cell extract on contaminated soil matrix, wet

| Initial Aroclor | Final Aroclor | Incubation | Reaction rate |
|---|---|---|---|
| (ppm) | (ppm) | time (d) | (K; d⁻¹) |
| 43 | 36 | 3 | 0.18 |
| 43 | 37 | 3 | 0.15 |
| 43 | 37 | 3 | 0.36 |

Experiment 2 - live cell on contaminated river mud matrix, wet

| Initial Aroclor | Final Aroclor | Incubation | Reaction rate |
|---|---|---|---|
| (ppm) | (ppm) | time (d) | (K; d−1) |
| 1.9 | 0.82 | 1 | 0.84 |
| Initial Dioxin | Final Dioxin | Incubation | Reaction rate |
| (TEQ/g) | (TEQ/g) | time (d) | (K; d⁻¹) |
| 730 | 450 | 1 | 0.48 |

Experiment 3 - cell extract on pre-cleaned sand, moist

| | | Incubation | Reaction rate |
|---|---|---|---|
| Initial BaP | Final BaP | time (d) | (K; d⁻¹) |
| — | <5% | 4 | 0.8 |
| Initial | Final | | |
| TCB | TCB | | |
| — | <5% | 4 | 0.8 |

Development of Methods of Bioremediation using Strain SH2B

The system of soil pretreatment and washing is shown schematically in FIG. 3. In order to effectively process contaminated soil, the soil underwent a pretreatment process to remove large clumps, stones, debris, etc. This was accomplished by first feeding the excavated material to the Delumping Unit, which ground the material to manageable sizes. Once the material was passed through the Delumping Unit, it was fed to the Vibrating Screen, which segregated the material further with oversize material larger than 100 mesh discarded. A centrifuge-like unit was also used in addition to segregate material by particle size and density. POPs were found to segregate mainly with fines such that course materials of greater than 500 microns in size generally had negligible levels of contamination. Alternatively sonic disruption was used to disperse aggregates of soil and organic matter such that contaminants are were thus made physically accessible for bioremediation. A slurry or solution of fines was produced by the addition of water or another fluid in order to facilitate manipulation of pH and other variables including agents active in colloidal suspension such as fumic acid, or humic acid, or another organic acids which served further to segregate POPs from association with fine particulate matter, and make them accessible for bioremediation.

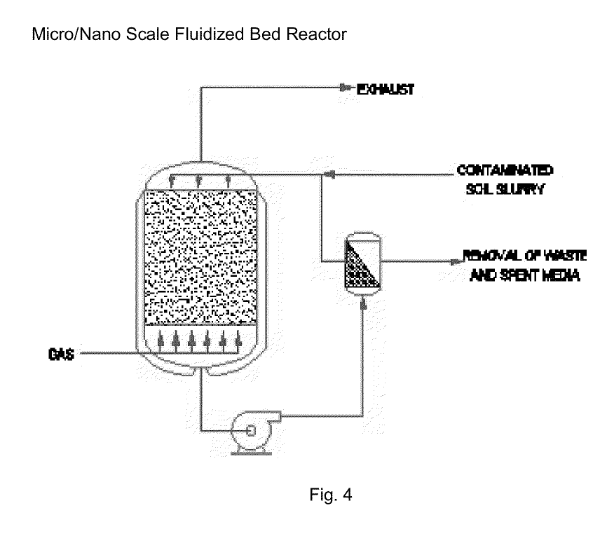

A schematic illustration of a fluidized bed reactor is shown in FIG. 4. Using a whole cell or a cell free enzyme approach, the fluidized bed reactor unit is inoculated with the proprietary cells. A nanoparticle, such as silica, is introduced into the unit at the start of the fermentation. The cells adhere to the nanoparticle while in a growth mode. Once the culture reaches a certain cell mass concentration, the contaminated soil slurry is fed to the unit. The gas sparge provides not only the required fluidization to keep the cells and slurry fluidized, but also the required oxygen substrate to maintain cell respiration. The cells or enzymes adhered to the nanoparticles provides a larger surface area for contaminate to attach to for the degradation reaction to occur. The unit is typically operated in a feed and bleed scenario whereby as new soil slurry is introduced to the unit, the same amount of waste is drawn off through the filter. The volatile air stream is condensed and adsorbed onto activated carbon to capture potential toxins volatilizing from the contaminated soil.

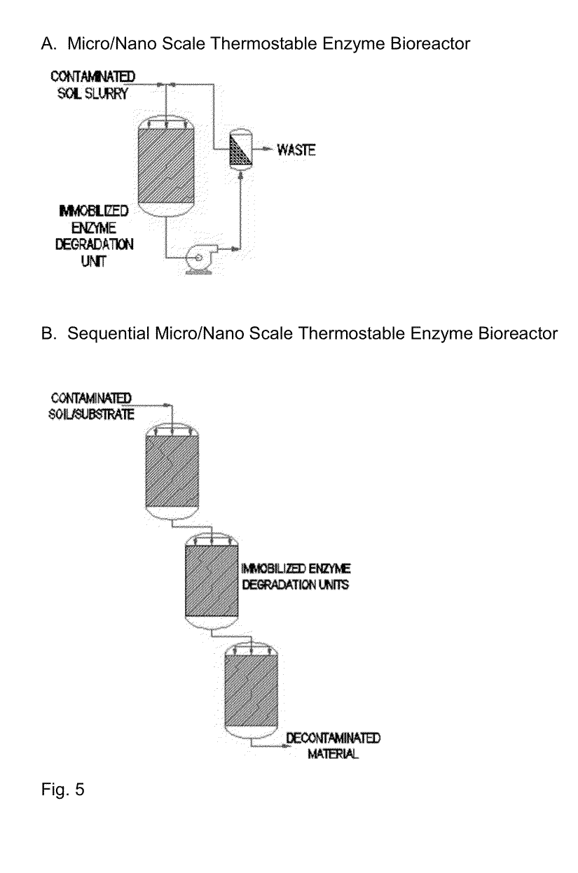

The system of bioremediation using an immobilized-enzyme packed bed reactor is shown in FIG. 5. In this application, the enzyme preparation was immobilized on a nanoparticle, such as silica, and packed into a fixed bed reactor (FIG. 5A). The contaminated soil slurry was then passed through the reactor, at an appropriate flow rate to ensure proper contact time between the soil slurry and immobilized enzyme. One single packed bed reactor was run in recycle mode, until either the transformation is complete or the enzyme has lost its activity. (FIG. 5B). Alternatively, the number of stages in a sequential series of packed bed reactors containing immobilized enzyme preparation that was required depended on the level of transformation obtained at each stage. The volatile air stream was condensed and adsorbed onto activated carbon to capture potential toxins volatilizing from the contaminated soil.

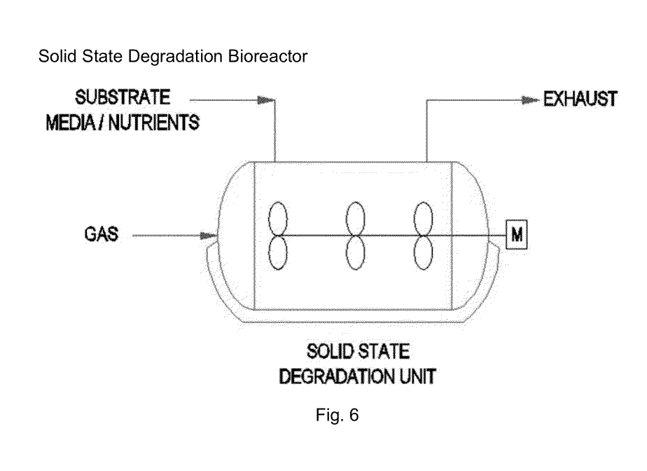

The system of solid state degradation was developed using a starter culture previously cultivated in a fermenter then transferred to the Degradation Unit along with media and nutrients is shown in FIG. 6. The Degradation Unit was operated in batch mode, with a set of paddle mixers providing gentle agitation, either continuously at low rpm or set to turn on periodically at predetermined intervals. The Degradation Unit was jacketed to provide the required heat within the chamber. Gas sparge was introduced to provide the required oxygen substrate necessary to maintain cell respiration. The air stream was condensed to capture potential condensables and the condensables tested for toxicity. The mixture within the unit normally had approximately 30-40% moisture level. The goal was to create an environment similar to compost whereby the proprietary organism is utilizes the organic matter and POPs associated with the contaminated soil as its substrate for growth and respiration. The volatile air stream was condensed and adsorbed onto activated carbon to capture potential toxins volatilizing from the contaminated soil.

Persistent organic pollutants, such as polychlorinated biphenyls (PCBs), and polychlorinated dibenzodioxins (PCDDs) are degraded by several types of bacteria. Degradation pathways associated with both anaerobic dehalogenation and oxidative catalysis were described previously. The following examples show the capability of enzyme extracts from a novel thermophilic bacterium to degrade several of the most problematic sediment organic contaminants. Isolations of several pure strains of bacteria that grew at elevated temperatures were made from a community composting facility located in urban Osaka, Japan.

Experiments were conducted to determine whether the use of SH2B-J2 strain-associated catalytic activity can potentially be utilized on a large scale to implement environmentally and economically sound waste disposal methods. We determined that the delivery system may consist of a drill boring or geoprobe. Once the probe has been set at an appropriate depth, the bacteria and growth media or alternatively enzyme preparation with necessary cofactors are pumped into the sediment via a delivery medium in conjunction with energy to produce heat in order to facilitate the thermophilic reaction. The delivery medium can take the form of an aqueous solution, suspension, or an aerosol spray. The amount of energy required for thermophilic biodegradation, and thus the cost, is likely to be much reduced because of lower temperatures compared to standard thermal degradation or incineration.

In a preferred embodiment of the present invention, the bioremediation agent in the form of live strain SH2B-J2 bacterial cells in the presence of growth supporting media, or alternatively enzyme preparation with necessary cofactors, is applied through direct injection into a monitoring well that is designed to come in direct contact with the impacted soil media in the subsurface.

The bioremediation agent may be in an aqueous form and pumped down the monitoring well under very low pressures (5 to 6 psi) to the subsurface. The bioremediation agent may enter the impacted soil media through the screened interval of the monitoring well. Multiple monitoring well points, of similar construction may be specified for each project area, based upon site specific information pertaining to the configuration of the contaminant plume, and subsurface characteristics of the impacted sediment

Some of the variables addressed include:
Development of appropriate delivery pressures for varying sediment porosities to maximize radius of influence.
Determination of the effect of ambient matrix quality parameters on the effectiveness of the bacterial enzymes (e.g., aeration, pH, redox potential, conductivity, etc.).
Determination of the efficiency of thermophilic biodegradation in the presence of natural complex organics, e.g., humic acids, tend to bind organic pollutants and reduce degradation efficiency.

The approach set out by applicants has the potential to be a rapid and cost effective method to remediate persistent organic pollutants in aquatic sediments and terrestrial soils with reduced impact to the natural environment compared to traditional remediation methods. Another major advantage to this approach is that it could offer a more permanent resolution to the existence of PCBs, and dioxins compared to extraction, dredging or capping which do not eliminate the contaminants.

The results demonstrate the efficacy of both whole cell cultures and crude enzyme extracts of G. miduosuji in rapidly eliminating highly toxic organic compounds such as those that persist in the environment and are problematic.

The ability of the enzyme systems in this extreme thermophile to function at elevated temperatures (60-80° C.) may be related to its broad catalytic capabilities as well as to the rapid biodegradation observed.

### Examples

The following example illustrates various aspects of the present invention, and is not intended to limit the scope of the invention.

The G. midousuji strain SH2B-J2 is a gram-positive rod shaped bacterium capable of sporulation, and a novel extreme thermophile which is related to G. thermodenitrificans by DNA sequence homology.

G. midousuji strain SH2B-J2 exhibits a diverse catalytic activity in its ability to rapidly degrade several toxic halogenated aromatic compounds. The ability of G. midousuji strain SH2B-J2 to utilize complex hydrocarbons, polyaromatics and polychlorinated dibenzofurans as sole carbon sources may be significant in the context of its ecological adaptation to an urban post-industrial environment.

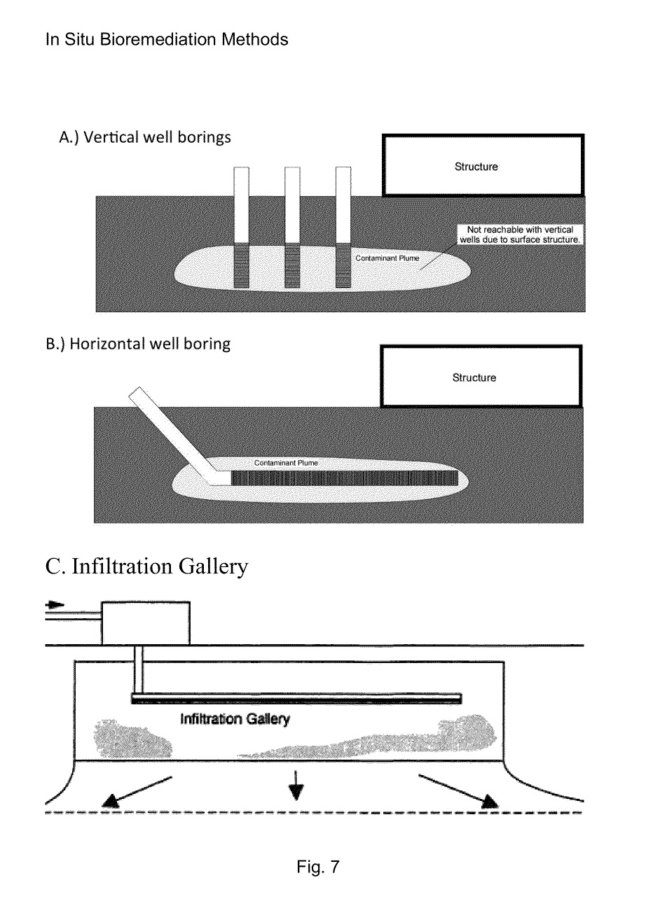

Schematic representations of major approaches to in-situ bioremediation using the thermophilic bacterium or its enzyme products are shown in FIG. 7. Vertical and or horizontal wells are placed at predetermined intervals based upon field performance testing determined to be sufficient for effective delivery and monitoring purposes. A.) Accessing the polluted material via vertical drilling. The bioremediation agent and associated, gases, nutritive agents and desorbants are introduced from the surface and pumped under predetermined pressures into the surrounding material. Resistive or direct heating is used to heat the area around the drill head during the period of the incubation. As for vertical drilling, materials are introduced under pressure in the surrounding area and resistive or direct heating is used to heat the area around the drill head during the period of the incubation. B.) Accessing the polluted material via horizontal drilling. This approach has the advantage of being able to access pollutants in less transmissive formations; under existing structures and/or rock that would otherwise be difficult to penetrate and or transmit a bioremediation agent and achieve contact with a pollutant. The volatile air stream is condensed and adsorbed onto activated carbon to capture potential toxins volatilizing from the contaminated soil. C.) Accessing the polluted material via infiltration gallery. This approach uses a partial excavation to gain access to the contaminated material, wherein geoprobes are put into the excavation which is backfilled with a porous material to allow the bioremediation agent to reach the contaminated material.

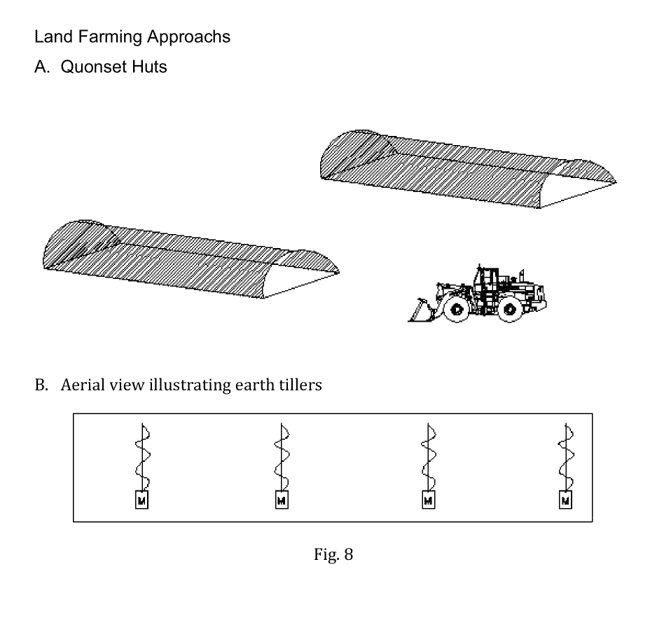

A system of land farming which utilizes a Quonset but or greenhouse structure is shown in FIG. 8. The structure is sealed as tightly as possible, with an impervious barrier employed on ground to provide complete containment of the contaminated material. The excavated, contaminated soil is set inside the Greenhouse. In one application live cells are utilized and a starter culture is cultivated in a fermenter then transferred to the Greenhouse. Once in the Greenhouse, the culture is mixed with the contaminated soil, then the Greenhouse sealed up. Heat is provided through exogenous and endogenous sources and the soil is periodically mixed, either by hand or by mechanical augers, appropriately spaced within the Greenhouse. A small airflow is introduced into the Greenhouse to not only provide temperature uniformity within the Greenhouse, but also to remove any potentially toxic volatiles. The airstream is condensed and adsorbed onto activated carbon to capture potential toxins volatilizing from the contaminated soil. In another application a cell-free system is used in which, inside the Greenhouse, the contaminated soil is mixed with an enzyme preparation and the requisite cofactors as described above, then the Greenhouse is sealed up. In the latter case it may be possible to use an aerosol spray to disperse the bioremediation agent over the substrate. Heat is provided through exogenous and endogenous sources and the soil is periodically mixed, either by hand or by mechanical augers, appropriately spaced within the Greenhouse. A small airflow is introduced into the Greenhouse to not only provide temperature uniformity within the Greenhouse, but also to remove any potentially toxic volatiles. The air stream is condensed and adsorbed onto activated carbon to capture potential toxins volatilizing from the contaminated soil.

1. A method of degrading persistent organic pollutants present in soil, sediment or wastewater, in-situ, said method comprising:
(a) pretreating the soil, sediment or wastewater using a suitable first delivery system;
(b) exposing the soil, sediment or waste water to a thermophilic bacterium capable of degrading organic contaminants using a second delivery system, together with a growth substrate and/or oxygen;
(c) subjecting soil, sediment or wastewater to heat treatment for a period of time sufficient to result in marked reductions in the levels of organic contaminants;
(d) aerating the soil, sediment or wastewater at the same time or before the introduction of the heat treatment; and
(e) monitoring the degradation of the organic contaminants.

2. The method of claim 1, wherein the first delivery system and the second delivery system are identical.

3. The method of claim 1, wherein the delivery system in step (a) consists of (i) borings either vertical or horizontal, or galleries installed at a site to be remediated into which are inserted hollow pipes or geoprobes or properly designed well screens capable of transmission of fluids, gases and suspensions therein; or (ii) equipment designed and manufactured specifically to manage waste flows in the form of batch or continuous extractions, centrifugation, sonic disruption, hydraulic fracturing, or similar methods of infusion of fluids and suspensions

4. The method of claim 1, wherein the delivery system in step (b) consists of (i) borings either vertical or horizontal, or galleries installed at a site to be remediated into which are inserted hollow pipes or geoprobes or properly designed well screens capable of transmission of fluids, gases and suspensions therein; or (ii) equipment designed and manufactured as a reaction vessel for solid phase, fluidized bed, slurry or immobilized bed reactor or similar incubation device capable of holding at a given temperature a volume of reactant.

5. The method of claim 1, wherein said organic contaminants are aromatic hydrocarbons.

6. The method of claim 5, wherein said aromatic hydrocarbons are polyaromatic hydrocarbons.

7. The method of claim 1, wherein the thermophilic bacterium is G. midousuji strain J2 SHB2-J2.

8. The method of claim 1, wherein the thermophilic bacterium strain is Geobacillus thermodinitrificans.

9. The method of claim 1, wherein said thermophilic bacterium is in the form of whole cells, mutants thereof.

10. The method of claim 1, wherein in step (b) the soil, sediment or wastewater is exposed to enzymes extracted and purified from said thermophilic bacteria.

11. The method of claim 1, wherein in step (b) live thermophilic bacterium is dispersed into said soil, sediment or wastewater.

12. The method of claim 1, wherein in step (b) enzymes extracted and purified from the thermophilic bacteria is dispersed into said soil, sediment or wastewater.

13. The method of claim 1, wherein the extraction includes solid liquid phase extraction and washing under acidic condition.

14. The method of claim 1, wherein the persistent organic pollutants include polychlorinated biphenyls, polyaromatic hydrocarbons, polychlorinated dibenzyl dioxins and/or dibenzyl furans.

15. The method of claim 14, wherein the aromatic hydrocarbons include or polyaromatic hydrocarbons.

16. The method of claim 1, wherein the method is carried out in a pH range of from about 5 to about 9.

17. The method of claim 1, wherein the pretreatment includes bioventing, sparging, redox sparging, soil-venting or hydraulic fracturing.

18. The method of claim 1, wherein the thermophilic bacteria are fractionated into one or more biochemical preparation which possesses the persistent organic pollutants catabolic activity.

19. The method of claim 1, wherein a biochemical preparation which possessed the persistent organic pollutants catabolic activity is immobilized on an elemental or organic micro- or nano-scale media.

20. The method of claim 1, wherein the thermophilic bacteria are fractionated and the necessary enzymatic cofactors and or biochemical conditions for persistent organic pollutants catabolic activity are met.

21. A method for ex-situ removal of persistent organic pollutants from industrially impacted sites, which method comprises:
(a) excavating and/or removal of soil, sediments or wastewater to a processing facility;
(b) pretreating the soil, sediment or wastewater using a suitable first delivery system;
(c) exposing the soil, sediment or waste water to a thermophilic bacterium capable of degrading organic contaminants using a second delivery system, together with a growth substrate and/or oxygen;
(d) subjecting soil, sediment or wastewater to heat treatment for a period of time sufficient to result in marked reductions in the levels of organic contaminants;
(e) aerating the soil, sediment or wastewater at the same time or before the introduction of the heat treatment; and
(f) monitoring the degradation of the organic contaminants.
wherein the delivery system in steps (b) and (c) may the same and wherein the delivery system in step (a) consists of (i) borings either vertical or horizontal, or galleries installed at a site to be remediated into which are inserted hollow pipes or geoprobes or properly designed well screens capable of transmission of fluids, gases and suspensions therein; or (ii) equipment designed and manufactured specifically to manage waste flows in the form of batch or continuous extractions, centrifugation, sonic disruption, hydraulic fracturing, or similar methods of infusion of fluids and suspensions; and the delivery system in step (b) consists of (i) borings either vertical or horizontal, or galleries installed at a site to be remediated into which are inserted hollow pipes or geoprobes or properly designed well screens capable of transmission of fluids, gases and suspensions therein; or (ii) equipment designed and manufactured as a reaction vessel for solid phase, fluidized bed, slurry or immobilized bed reactor or similar incubation device capable of holding at a given temperature a volume of reactant.
